(19) United States
(12) Patent Application Publication
(10) Pub. No.: US 2025/0370721 A1
(43) Pub. Date: Dec. 4, 2025

(54) METHOD AND SYSTEM FOR IMPROVING CODE GENERATION QUALITY OF LARGE LANGUAGE MODEL THROUGH CODE GUARDRAILS

(71) Applicant: JPMorgan Chase Bank, N.A., New York, NY (US)

(72) Inventors: Nishan SRISHANKAR, Secaucus, NJ (US); William WATSON, Long Beach, NY (US); Naan CHO, New York, NY (US); Manuela VELOSO, New York, NY (US)

(73) Assignee: JPMorgan Chase Bank, N.A., New York, NY (US)

(21) Appl. No.: 18/675,688

(22) Filed: May 28, 2024

(51) Int. Cl. G06F 8/30

(52) U.S. Cl. CPC G06F 8/30

(57) ABSTRACT

A method and a system for improving a quality of software code generated by using a large language model (LLM) via code guardrails are provided. The method includes: receiving a request for performing a task; providing the request as an input to the LLM; receiving, from the LLM, a first set of executable code that is intended to be usable for performing the task; automatically executing the first set of executable code in an environment that includes at least one guardrail component that is configured to detect errors; detecting at least one error, such as a hallucination error, based on a result of the execution; determining at least one feedback item based on the at least one error; and prompting the LLM to generate a second set of executable code based on the request, the first set of executable code, and the at least one feedback item.

### BACKGROUND

### 1. Field of the Disclosure

This technology generally relates to methods and systems for generating software code, and more particularly to methods and systems for improving a quality of software code generated by using a large language model via code guardrails.

### 2. Background Information

The use of a large language model (LLM) for software code generation offers several advantages, including the ability of the LLM to understand the semantics of a user query, the ability to translate queries into target languages, the ability to follow instructions, and the ability to engage in conversational feedback. However, LLMs also come with certain disadvantages. A first disadvantage relates to hallucination of methods and tools: LLMs may generate code that includes methods or tools not implemented or available, thus leading to errors or incorrect results. A second disadvantage relates to hallucination of function parameters: LLMs may generate code with function parameters that are not part of the original declaration, thus leading to code that does not align with the intended functionality. A third disadvantage relates to improper usage of application programming interfaces (APIs): LLMs, which are text-based models, may struggle with understanding the underlying variables and type inference required for proper API usage, thus leading to code that does not execute correctly. A fourth disadvantage relates to a lack of general knowledge of custom tool use and best practices: LLMs do not possess inherent knowledge of custom tools or the best practices for their implementation, which limits the ability of an LLM to generate optimal code.

Conventionally, users manually interact with an LLM using a set of conditions. Further, users typically need to extract code snippets from the model's response and then execute the code snippets in a separate environment. Additionally, users need to manually configure feedback for subsequent conversation rounds. This manual process is time-consuming and places a significant burden on the user, requiring the user to have a high level of control and involvement throughout the interaction. This implies that a user must be knowledgeable of programming and/or the tools in use, thereby limiting the applicability and availability of any orchestration system to programmers alone. This creates a high barrier to entry in any baseline system.

Accordingly, there is a need for a mechanism for improving a quality of software code generated by using an LLM via code guardrails.

### SUMMARY

The present disclosure, through one or more of its various aspects, embodiments, and/or specific features or sub-components, provides, inter alia, various systems, servers, devices, methods, media, programs, and platforms for improving a quality of software code generated by using an LLM via code guardrails.

According to an aspect of the present disclosure, a method for improving a quality of software code is provided. The method is implemented by at least one processor. The method includes: receiving, by the at least one processor, a first request for performing a first task; providing, by the at least one processor as an input to a first large language model (LLM), the first request; receiving, by the at least one processor from the first LLM, a first set of executable code that is intended to be usable for performing the first task; automatically executing the first set of executable code in an environment that includes at least one guardrail component that is configured to detect at least one type of error; detecting at least one error based on a result of the executing; determining at least one feedback item based on the at least one error; and prompting the first LLM to generate a second set of executable code based on the first request, the first set of executable code, and the at least one feedback item.

The at least one error may include at least one from among a hallucination error, an application programming interface (API) type error, an execution error, a runtime error, a syntax error, and a return none error that relates to a failure to generate a return to a call.

The hallucination error may include at least one from among a first hallucination error that relates to a tool that is usable for performing the first task, a second hallucination error that relates to a parameter that is usable for performing the first task, a third hallucination error that relates to a context of the first task, and a fourth hallucination error that relates to a semantic meaning of a variable that is usable for performing the first task.

The at least one feedback item may include an identification of a specific line of code from within the first set of executable code that is indicated as causing the at least one error.

The method may further include providing, as an input for training the first LLM, a third set of executable code and information indicating that the third set of executable code is effective for performing a task that corresponds to the third set of executable code.

The method may further include providing, as an additional input for training the first LLM, a fourth set of executable code and information indicating that the fourth set of executable code is not effective for performing a task that corresponds to the fourth set of executable code.

The method may further include: automatically executing the second set of executable code in the environment that includes the at least one guardrail component; detecting at least one additional error based on a result of the executing of the second set of executable code; determining at least one additional feedback item based on the at least one additional error; and prompting the first LLM to generate a third set of executable code based on the first request, the first set of executable code, the second set of executable code, the at least one feedback item, and the at least one additional feedback item.

The method may further include: providing the second set of executable code as an input to a second LLM; and receiving, from the second LLM, information that relates to an evaluation of a suitability of the second set of executable code with respect to performing the first task.

The information received from the second LLM may include at least one from among information that relates to whether the second set of executable code calls proper application programming interfaces (APIs) for performing the first task and an indication of an optimality of the second set of executable code.

According to another exemplary embodiment, a computing apparatus for improving a quality of software code is provided. The computing apparatus includes a processor; a memory; and a communication interface coupled to each of the processor and the memory. The processor is configured to: receive, via the communication interface, a first request for performing a first task; provide, as an input to a first large language model (LLM), the first request; receive, from the first LLM via the communication interface, a first set of executable code that is intended to be usable for performing the first task; automatically execute the first set of executable code in an environment that includes at least one guardrail component that is configured to detect at least one type of error; detect at least one error based on a result of the executing; determine at least one feedback item based on the at least one error; and prompt the first LLM to generate a second set of executable code based on the first request, the first set of executable code, and the at least one feedback item.

The at least one error may include at least one from among a hallucination error, an application programming interface (API) type error, an execution error, a runtime error, a syntax error, and a return none error that relates to a failure to generate a return to a call.

The hallucination error may include at least one from among a first hallucination error that relates to a tool that is usable for performing the first task, a second hallucination error that relates to a parameter that is usable for performing the first task, a third hallucination error that relates to a context of the first task, and a fourth hallucination error that relates to a semantic meaning of a variable that is usable for performing the first task.

The at least one feedback item may include an identification of a specific line of code from within the first set of executable code that is indicated as causing the at least one error.

The processor may be further configured to provide, as an input for training the first LLM, a third set of executable code and information indicating that the third set of executable code is effective for performing a task that corresponds to the third set of executable code.

The processor may be further configured to provide, as an additional input for training the first LLM, a fourth set of executable code and information indicating that the fourth set of executable code is not effective for performing a task that corresponds to the fourth set of executable code.

The processor may be further configured to: automatically execute the second set of executable code in the environment that includes the at least one guardrail component; detect at least one additional error based on a result of the executing of the second set of executable code; determine at least one additional feedback item based on the at least one additional error; and prompt the first LLM to generate a third set of executable code based on the first request, the first set of executable code, the second set of executable code, the at least one feedback item, and the at least one additional feedback item.

The processor may be further configured to: provide the second set of executable code as an input to a second LLM; and receive, from the second LLM via the communication interface, information that relates to an evaluation of a suitability of the second set of executable code with respect to performing the first task.

The information received from the second LLM may include at least one from among information that relates to whether the second set of executable code calls proper application programming interfaces (APIs) for performing the first task and an indication of an optimality of the second set of executable code.

According to yet another exemplary embodiment, a non-transitory computer readable storage medium storing instructions for improving a quality of software code is provided. The storage medium includes a first set of executable code which, when executed by a processor, causes the processor to: receive a first request for performing a first task; provide, as an input to a first large language model (LLM), the first request; receive, from the first LLM, a second set of executable code that is intended to be usable for performing the first task; automatically execute the second set of executable code in an environment that includes at least one guardrail component that is configured to detect at least one type of error; detect at least one error based on a result of the execution; determine at least one feedback item based on the at least one error; and prompt the first LLM to generate a third set of executable code based on the first request, the second set of executable code, and the at least one feedback item.

The at least one error may include at least one from among a hallucination error, an application programming interface (API) type error, an execution error, a runtime error, a syntax error, and a return none error that relates to a failure to generate a return to a call.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for improving a quality of software code generated by using an LLM via code guardrails.

FIG. 4 is a flowchart of an exemplary process for implementing a method for improving a quality of software code generated by using an LLM via code guardrails.

FIG. 5 is a workflow diagram of an automatic guardrail and feedback process as implemented in a system for improving a quality of software code generated by using an LLM via code guardrails, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

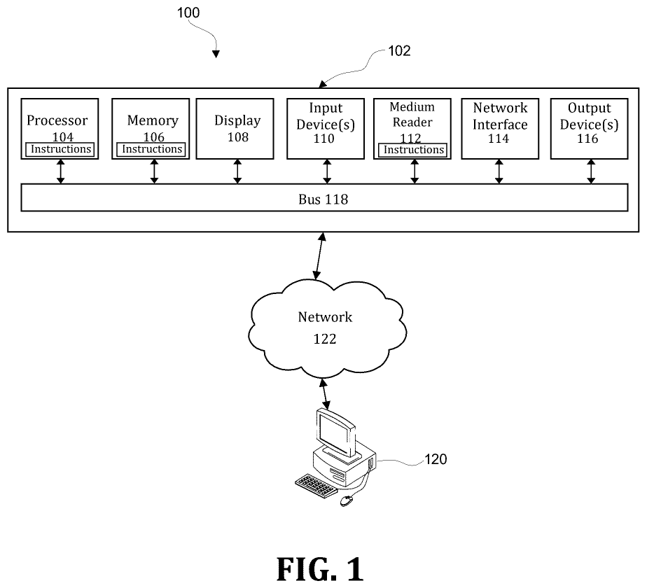

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for improving a quality of software code generated by using an LLM via code guardrails.

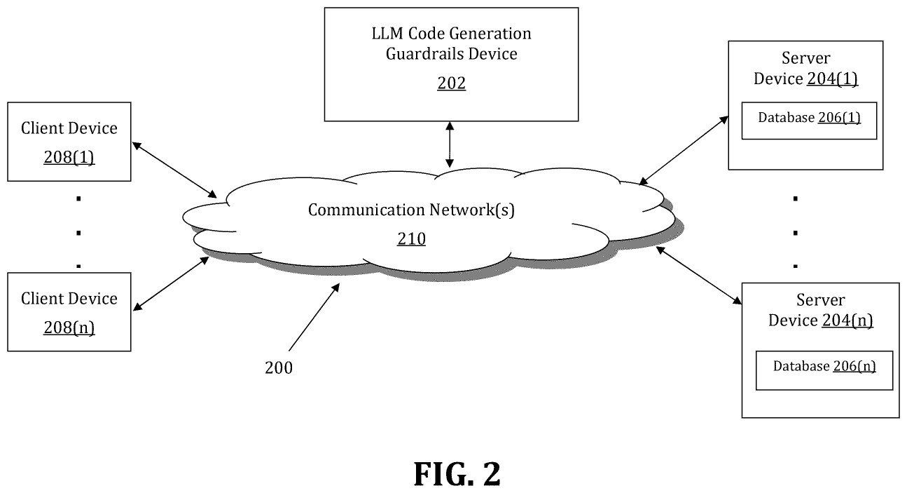

Referring to FIG. 2, a schematic of an exemplary network environment 200 for implementing a method for improving a quality of software code generated by using an LLM via code guardrails is illustrated. In an exemplary embodiment, the method is executable on any networked computer platform, such as, for example, a personal computer (PC).

The method for improving a quality of software code generated by using an LLM via code guardrails may be implemented by an LLM Code Generation Guardrails (LCGG) device 202. The LCGG device 202 may be the same or similar to the computer system 102 as described with respect to FIG. 1. The LCGG device 202 may store one or more applications that can include executable instructions that, when executed by the LCGG device 202, cause the LCGG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LCGG device 202 itself, may be located in virtual server(s) running in a cloud-based computing environment rather than being tied to one or more specific physical network computing devices. Also, the application(s) may be running in one or more virtual machines (VMs) executing on the LCGG device 202. Additionally, in one or more embodiments of this technology, virtual machine(s) running on the LCGG device 202 may be managed or supervised by a hypervisor.

In the network environment 200 of FIG. 2, the LCGG device 202 is coupled to a plurality of server devices 204(1)-204(n) that hosts a plurality of databases 206(1)-206(n), and also to a plurality of client devices 208(1)-208(n) via communication network(s) 210. A communication interface of the LCGG device 202, such as the network interface 114 of the computer system 102 of FIG. 1, operatively couples and communicates between the LCGG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LCGG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and LCGG devices that efficiently implement a method for improving a quality of software code generated by using an LLM via code guardrails.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LCGG device 202 may be a standalone device or integrated with one or more other devices or apparatuses, such as one or more of the server devices 204(1)-204(n), for example. In one particular example, the LCGG device 202 may include or be hosted by one of the server devices 204(1)-204(n), and other arrangements are also possible. Moreover, one or more of the devices of the LCGG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LCGG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to LLM-generated code and information that relates to errors and hallucinations.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the LCGG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the LCGG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the LCGG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the LCGG device 202, the server devices 204(1)-204(n), or the client devices 208(1)-208(n), for example, may be configured to operate as virtual instances on the same physical machine. In other words, one or more of the LCGG device 202, the server devices 204(1)-204(n), or the client devices 208(1)-208(n) may operate on the same physical device rather than as separate devices communicating through communication network(s) 210. Additionally, there may be more or fewer LCGG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

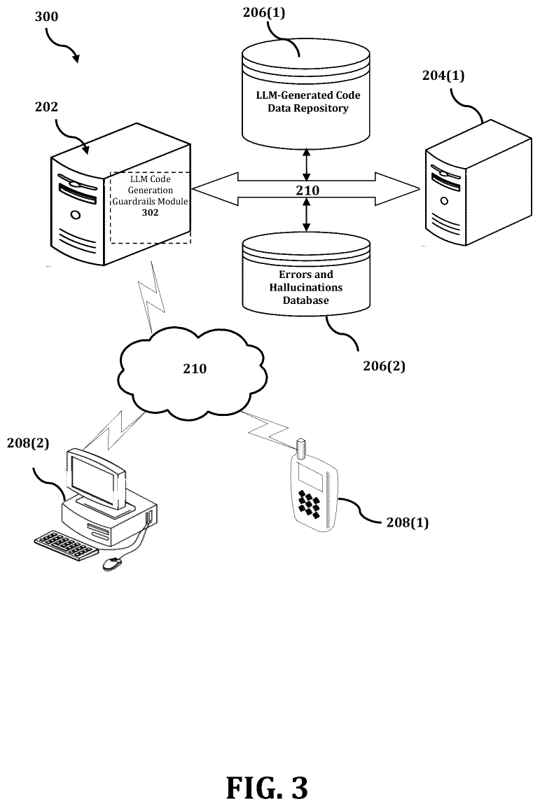

The LCGG device 202 is described and illustrated in FIG. 3 as including an LLM code generation guardrails module 302, although it may include other rules, policies, modules, databases, or applications, for example. As will be described below, the LLM code generation guardrails module 302 is configured to implement a method for improving a quality of software code generated by using an LLM via code guardrails.

An exemplary process 300 for implementing a mechanism for improving a quality of software code generated by using an LLM via code guardrails by utilizing the network environment of FIG. 2 is illustrated as being executed in FIG. 3. Specifically, a first client device 208(1) and a second client device 208(2) are illustrated as being in communication with LCGG device 202. In this regard, the first client device 208(1) and the second client device 208(2) may be “clients” of the LCGG device 202 and are described herein as such. Nevertheless, it is to be known and understood that the first client device 208(1) and/or the second client device 208(2) need not necessarily be “clients” of the LCGG device 202, or any entity described in association therewith herein. Any additional or alternative relationship may exist between either or both of the first client device 208(1) and the second client device 208(2) and the LCGG device 202, or no relationship may exist.

Further, LCGG device 202 is illustrated as being able to access an LLM-generated code data repository 206(1) and an errors and hallucinations database 206(2). The LLM code generation guardrails module 302 may be configured to access these databases for implementing a method for improving a quality of software code generated by using an LLM via code guardrails.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the LCGG device 202 via broadband or cellular communication. Of course, these embodiments are merely exemplary and are not limiting or exhaustive.

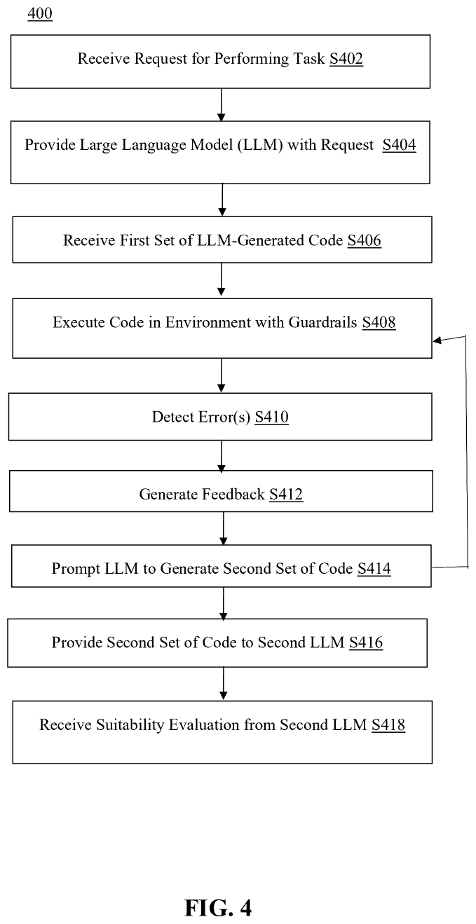

Upon being started, the LLM code generation guardrails module 302 executes a process for improving a quality of software code generated by using an LLM via code guardrails. An exemplary process for improving a quality of software code generated by using an LLM via code guardrails is generally indicated at flowchart 400 in FIG. 4.

In process 400 of FIG. 4, at step S402, the LLM code generation guardrails module 302 receives a first request for performing a first task. Then, at step S404, the LLM code generation guardrails module 302 provides an input to a first LLM that includes the first request. In an exemplary embodiment, as an input for training purposes the first LLM may be provided one or more “good” sets of executable code together with information indicating that each such good set of code is effective for performing a corresponding task, and/or one or more “bad” sets of executable code together with information indicating that each such bad set of code is not effective for performing the corresponding task.

At step S406, the LLM code generation guardrails module 302 receives a first set of executable code that is intended to be usable for performing the first task. Then, at step S408, the LLM code generation guardrails module 302 automatically executes the first set of code in an environment that includes at least one guardrail component that is configured to detect one or more types of errors. In an exemplary embodiment, various types of errors may detectable, including, for example, any one or more of a hallucination error, an application programming interface (API), an execution error, a runtime error, a syntax error, and/or a return none error that relates to a failure to generate a return to a call. Further, the hallucination error may include any one or more of a first hallucination error that relates to a tool that is usable for performing the first task, a second hallucination error that relates to a parameter that is usable for performing the first task, a third hallucination error that relates to a context of the first task, and a fourth hallucination error that relates to a semantic meaning of a variable that is usable for performing the first task.

At step S410, the LLM code generation guardrails module 302 detects at least one error based on a result of the execution of the first set of code in step S408. Then, at step S412, the LLM code generation guardrails module 302 generates at least one feedback item based on the detected error(s). In an exemplary embodiment, the feedback item may include an identification of one or more specific lines of code from within the first set of code that is indicated as causing the error(s) detected in step S410.

At step S414, the LLM code generation guardrails module 302 prompts the first LLM to generate a second set of executable code based on the first request, the first set of executable code, and the feedback item(s) generated in step S412. In this aspect, as a result of the feedback, the first LLM may be able to improve the quality of the executable code. Then, the second set of executable code may be cycled through steps S408, S410, S412, and S414 again to determine whether additional errors are present and to generate another set of executable code that represents a further improvement to the quality of the code. In an exemplary embodiment, these steps may be repeated any number of times in order to obtain an optimal set of executable code.

At step S416, the LLM code generation guardrails module 302 provides the second set of executable code, or potentially a subsequent set of executable code, to a second LLM with a request to perform a suitability evaluation with respect to the inputted code. Then, at step S418, the LLM code generation guardrails module 302 receives information that relates to the suitability evaluation from the second LLM. In an exemplary embodiment, the information that relates to the suitability evaluation may include information that indicates whether or not the executable code calls proper APIs for performing the first task and/or an indication of an optimality of the executable code with respect to performing the first task.

In an exemplary embodiment, the present inventive concept contemplates the implementation of an automatic guardrail system for improving the quality of software code generation by an LLM. The automatic guardrail system incorporates an automatic execution cycle that enables continuous monitoring and feedback on code errors through custom error messages. The automatic guardrail system also leverages in-context learning through examples and demonstrations to enhance the quality of code generation. In this aspect, an objective of the automatic guardrail system is to improve the effectiveness and reliability of LLMs by ensuring accurate tool usage, generating executable code, and adhering to tool specifications. In addition, the automation of the guardrail system streamlines the process of interacting with an LLM to identify and mitigate code generation errors and hallucinations by making this process less user-intensive and allowing users to focus on desired outcomes rather than the technical intricacies of code execution and feedback configuration.

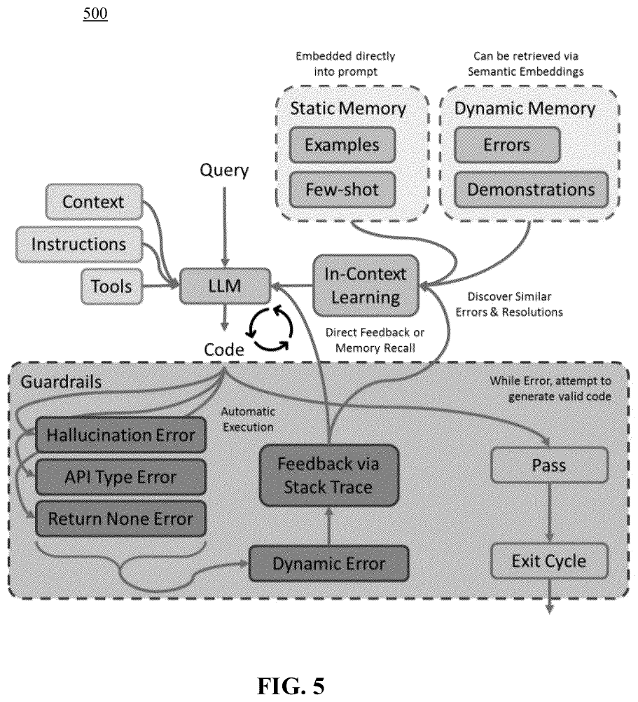

FIG. 5 is a workflow diagram 500 of an automatic guardrail and feedback process as implemented in a system for improving a quality of software code generated by using an LLM via code guardrails, according to an exemplary embodiment. As illustrated in FIG. 5, there are several components that are working in conjunction with one another to improve the quality of LLM code generation. A role section includes a context component, an instructions component, and a tools component. The tools component includes tool definitions and instructions that expose the commands that are available to the LLM for generating code. The instructions component provides semantic grounding to the tool use, the available parameters, and the types of parameters to be used by the LLM. The context component includes information that relates to the goal that the LLM is attempting to accomplish.

Referring again to FIG. 5, an in-context learning section provides examples of good and bad code generation based on the tools provided. A static memory component includes hard-coded and embedded examples to be incorporated into a prompt, and also includes a few-shot module that provides a set number of examples for reference by the LLM. A dynamic memory component may be represented as a vector database of demonstrations, solutions, and prior examples linked to previous LLM queries. In an exemplary embodiment, the dynamic memory component may use a semantic embedding model to discover similar queries or errors in order to improve the in-context learning of the LLM.

Referring again to FIG. 5, a guardrails section includes code guardrails that monitor and profile the code execution and tool usage after generation. After the LLM receives a query and generates executable software code that is intended to be responsive to the query, the LLM outputs the code, which may then be provided to the guardrails section. In the guardrails section, the generated code can be automatically executed in a preconfigured environment.

During the execution, specific events may be triggered. A hallucination error guardrail component may be triggered when the LLM hallucinates either a tool or a parameter to a tool. The hallucination error guardrail component is implemented by catching the keyword arguments of a function, then identifying which keyword arguments are hallucinated. In addition, the semantic meaning of the variable may be used to correlate the variable with acceptable parameters if they are sufficiently similar. For instance, when querying for data between a start year and an end year, an LLM may hallucinate “between_years=[2015, 2020]”, while acceptable parameters would be “start_year=2015, end_year=2020”. With this implementation, it is possible to identify all hallucinated parameters and offer suggestions to correct usage.

An API type error guardrail component may be triggered when a variable does not conform to an expected variable type. For instance, if a tool expects a year as an integer (2015), but the LLM generates a string object “2015”, then the API type error guardrail component catches the exact variable that is causing the error.

A return none error guardrail component automatically catches errors related to bad filters. For example, when no response is returned from a tool call, the return none error guardrail component catches this error. Such an error provides direct feedback on which tool caused the error and where the issue occurred.

A feedback via stack trace component observes standard errors, including syntax errors, execution errors, and/or runtime errors, and directly identifies the offensive line of code as feedback. As a result, certain pieces of code may be targeted iteratively to improve execution. In addition, any issues that are identified can be embedded and retrieved from a vector database of errors to improve the in-context learning prompt for the next conversation cycle.

Semantic checking of code: In an exemplary embodiment, an additional critic LLM may be leveraged to evaluate the suitability of the code that has been generated for the required task. For example, the critic LLM may determine whether the proper APIs are called for the specific task. This evaluation also facilitates a judgment as to whether the code that has been generated is optimal for the task.

In an exemplary embodiment, the automatic guardrail system incorporates the guardrails described above, provides specific targeted feedback, and re-prompts an LLM to improve generated code. This process may be repeated for any arbitrary number of rounds, such as two (2), three (3, five (5), or more.

Accordingly, with this technology, an optimized process for improving a quality of software code generated by using an LLM via code guardrails is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for improving a quality of software code, the method being implemented by at least one processor, the method comprising:
receiving, by the at least one processor, a first request for performing a first task;
providing, by the at least one processor as an input to a first large language model (LLM), the first request;
receiving, by the at least one processor from the first LLM, a first set of executable code that is intended to be usable for performing the first task;
automatically executing the first set of executable code in an environment that includes at least one guardrail component that is configured to detect at least one type of error;
detecting at least one error based on a result of the executing;
determining at least one feedback item based on the at least one error; and
prompting the first LLM to generate a second set of executable code based on the first request, the first set of executable code, and the at least one feedback item.

2. The method of claim 1, wherein the at least one error includes at least one from among a hallucination error, an application programming interface (API) type error, an execution error, a runtime error, a syntax error, and a return none error that relates to a failure to generate a return to a call.

3. The method of claim 1, wherein the hallucination error includes at least one from among a first hallucination error that relates to a tool that is usable for performing the first task, a second hallucination error that relates to a parameter that is usable for performing the first task, a third hallucination error that relates to a context of the first task, and a fourth hallucination error that relates to a semantic meaning of a variable that is usable for performing the first task.

4. The method of claim 1, wherein the at least one feedback item includes an identification of a specific line of code from within the first set of executable code that is indicated as causing the at least one error.

5. The method of claim 1, further comprising providing, as an input for training the first LLM, a third set of executable code and information indicating that the third set of executable code is effective for performing a task that corresponds to the third set of executable code.

6. The method of claim 5, further comprising providing, as an additional input for training the first LLM, a fourth set of executable code and information indicating that the fourth set of executable code is not effective for performing a task that corresponds to the fourth set of executable code.

7. The method of claim 1, further comprising:
automatically executing the second set of executable code in the environment that includes the at least one guardrail component;
detecting at least one additional error based on a result of the executing of the second set of executable code;
determining at least one additional feedback item based on the at least one additional error; and
prompting the first LLM to generate a third set of executable code based on the first request, the first set of executable code, the second set of executable code, the at least one feedback item, and the at least one additional feedback item.

8. The method of claim 1, further comprising:
providing the second set of executable code as an input to a second LLM; and
receiving, from the second LLM, information that relates to an evaluation of a suitability of the second set of executable code with respect to performing the first task.

9. The method of claim 8, wherein the information received from the second LLM includes at least one from among information that relates to whether the second set of executable code calls proper application programming interfaces (APIs) for performing the first task and an indication of an optimality of the second set of executable code.

10. A computing apparatus for improving a quality of software code, the computing apparatus comprising:
a processor;
a memory; and
a communication interface coupled to each of the processor, the memory, and the display,
wherein the processor is configured to:
receive, via the communication interface, a first request for performing a first task;
provide, as an input to a first large language model (LLM), the first request;
receive, from the first LLM via the communication interface, a first set of executable code that is intended to be usable for performing the first task;
automatically execute the first set of executable code in an environment that includes at least one guardrail component that is configured to detect at least one type of error;
detect at least one error based on a result of the executing;
determine at least one feedback item based on the at least one error; and
prompt the first LLM to generate a second set of executable code based on the first request, the first set of executable code, and the at least one feedback item.

11. The computing apparatus of claim 10, wherein the at least one error includes at least one from among a hallucination error, an application programming interface (API) type error, an execution error, a runtime error, a syntax error, and a return none error that relates to a failure to generate a return to a call.

12. The computing apparatus of claim 10, wherein the hallucination error includes at least one from among a first hallucination error that relates to a tool that is usable for performing the first task, a second hallucination error that relates to a parameter that is usable for performing the first task, a third hallucination error that relates to a context of the first task, and a fourth hallucination error that relates to a semantic meaning of a variable that is usable for performing the first task.

13. The computing apparatus of claim 10, wherein the at least one feedback item includes an identification of a specific line of code from within the first set of executable code that is indicated as causing the at least one error.

14. The computing apparatus of claim 10, wherein the processor is further configured to provide, as an input for training the first LLM, a third set of executable code and information indicating that the third set of executable code is effective for performing a task that corresponds to the third set of executable code.

15. The computing apparatus of claim 14, wherein the processor is further configured to provide, as an additional input for training the first LLM, a fourth set of executable code and information indicating that the fourth set of executable code is not effective for performing a task that corresponds to the fourth set of executable code.

16. The computing apparatus of claim 10, wherein the processor is further configured to:
automatically execute the second set of executable code in the environment that includes the at least one guardrail component;
detect at least one additional error based on a result of the executing of the second set of executable code;
determine at least one additional feedback item based on the at least one additional error; and
prompt the first LLM to generate a third set of executable code based on the first request, the first set of executable code, the second set of executable code, the at least one feedback item, and the at least one additional feedback item.

17. The computing apparatus of claim 10, wherein the processor is further configured to:
provide the second set of executable code as an input to a second LLM; and
receive, from the second LLM via the communication interface, information that relates to an evaluation of a suitability of the second set of executable code with respect to performing the first task.

18. The computing apparatus of claim 17, wherein the information received from the second LLM includes at least one from among information that relates to whether the second set of executable code calls proper application programming interfaces (APIs) for performing the first task and an indication of an optimality of the second set of executable code.

19. A non-transitory computer readable storage medium storing instructions for improving a quality of software code, the storage medium comprising a first set of executable code which, when executed by a processor, causes the processor to:
receive a first request for performing a first task;
provide, as an input to a first large language model (LLM), the first request;
receive, from the first LLM, a second set of executable code that is intended to be usable for performing the first task;
automatically execute the second set of executable code in an environment that includes at least one guardrail component that is configured to detect at least one type of error;
detect at least one error based on a result of the execution;
determine at least one feedback item based on the at least one error; and
prompt the first LLM to generate a third set of executable code based on the first request, the second set of executable code, and the at least one feedback item.

20. The storage medium of claim 19, wherein the at least one error includes at least one from among a hallucination error, an application programming interface (API) type error, an execution error, a runtime error, a syntax error, and a return none error that relates to a failure to generate a return to a call.
